(19) United States
(12) Patent Application Publication
(10) Pub. No.: US 2024/0428287 A1
(43) Pub. Date: Dec. 26, 2024

(54) POINT MANAGEMENT SYSTEM, POINT MANAGEMENT METHOD, AND NON-TRANSITORY COMPUTER-READABLE MEDIUM

(71) Applicant: NEC Corporation, Minato-ku, Tokyo (JP)

(72) Inventors: Naoto FUKUDA, Tokyo (JP); Daichi SATO, Tokyo (JP); Akihisa SUDOU, Tokyo (JP); Daisuke KAWASAKI, Tokyo (JP); Kaori YAMANE, Tokyo (JP)

(73) Assignee: NEC Corporation, Minato-ku, Tokyo (JP)

(21) Appl. No.: 18/274,116

(22) PCT Filed: Jan. 27, 2021
(86) PCT No.: PCT/JP2021/002774

§ 371 Date: Jul. 25, 2023

(51) Int. Cl. G06Q 30/0226; G06Q 20/06; G06Q 50/40

(52) U.S. Cl. CPC G06Q 30/0226; G06Q 20/06; G06Q 50/40

(57) ABSTRACT

A point management system (10) manages first points required for receiving a first service. The first points are managed for each group to which a plurality of persons belong. A second apparatus (30) acquires service determination information for determining the type of the first service provided to a user being one of the plurality of persons. A first apparatus (20) determines the number of required points being the number of first points required for the first service by using the service determination information. The second apparatus (30) performs processing for providing the first service to the user. Further, the second apparatus (30) reduces the first points by the number of required points.

### TECHNICAL FIELD

The present invention relates to a point management system, a point management method, and a program.

### BACKGROUND ART

A person belonging to a group such as an enterprise may use a public transportation system at the expense of the group. For example, Patent Document 1 describes a company that contracts with a railroad company lending a contactless commuter pass to an employee. In Patent Document 1, the contracting company pays the railroad company for the contactless commuter pass.

Further, Patent Document 2 also describes an enterprise paying for a commuter pass of an employee. Patent Document 2 further describes an apparatus at the enterprise deducting an excess fare for use outside a stipulated section of a commuter pass from a salary.

### RELATED DOCUMENT

### Patent Document

Patent Document 1: Japanese Patent Application Publication No. 2008-084346
Patent Document 2: Japanese Patent Application Publication No. 2008-250428

### SUMMARY OF INVENTION

### Technical Problem

A person belonging to a group such as an enterprise may receive provision of a service at the expense of the group. For some types of service, a price is determined and payment is required every time provision of the service is received. An example of an object of the present invention is to reduce efforts by both the group and the person in such a case.

### Solution to Problem

The present invention provides a point management system managing one or more first points required for receiving a first service, the first points being managed for each group to which a plurality of persons belong, the point management system including:
an acquisition unit that acquires service determination information for determining a type of the first service provided to a user being one of the plurality of persons;
a determination unit that determines a number of one or more required points being a number of the one or more first points required for the first service by using the service determination information;
a service provision unit that performs processing for providing the first service to the user; and
a point management unit that reduces the first points by the number of required points.

The present invention provides a point management method for managing one or more first points required for receiving a first service, the first points being managed for each group to which a plurality of persons belong, the point management method performing, by using at least one computer:
acquisition processing of acquiring service determination information for determining a type of the first service provided to a user being one of the plurality of persons;
determination processing of determining a number of one or more required points being a number of the one or more first points required for the first service by using the service determination information;
service provision processing of performing processing for providing the first service to the user; and
point management processing of reducing the first points by the number of required points.

The present invention provides a program for causing a system including at least one computer to operate as a point management system managing one or more first points required for receiving a first service, the first points being managed for each group to which a plurality of persons belong, the program causing the system to execute:
an acquisition function of acquiring service determination information for determining a type of the first service provided to a user being one of the plurality of persons;
a determination function of determining a number of one or more required points being a number of the one or more first points required for the first service by using the service determination information;
a service provision function of performing processing for providing the first service to the user; and
a point management function of reducing the first points by the number of required points.

### Advantageous Effects of Invention

The present invention reduces efforts required of a group such as an enterprise and efforts by a person belonging to the group when the person receives provision of a service at the expense of the group.

### BRIEF DESCRIPTION OF THE DRAWINGS

The aforementioned object, and other objects, features, and advantages will become more apparent by use of the following preferred example embodiments and accompanying drawings.

FIG. 1 It is a diagram illustrating an outline of a configuration of a point management system according to a first example embodiment along with a terminal.

FIG. 2 It is a diagram illustrating an example of a functional configuration of a first apparatus.

FIG. 3 It is a diagram illustrating an example of a functional configuration of a second apparatus.

FIG. 4 It is a diagram illustrating an example of information stored in a user information storage unit.

FIG. 5 It is a diagram illustrating an example of information stored in a point management unit.

FIG. 6 It is a diagram illustrating a hardware configuration example of the first apparatus.

FIG. 7 It is a diagram illustrating an example of processing performed by the point management system when a user uses a first service.

FIG. 8 It is a flowchart illustrating a modified example of FIG. 7.

FIG. 9 It is a diagram illustrating an example of a functional configuration of a first apparatus according to a second example embodiment.

FIG. 10 It is a diagram illustrating a first example of a data structure of a point storage unit according to the second example embodiment.

FIG. 11 It is a diagram illustrating a second example of a data structure of the point storage unit according to the second example embodiment.

FIG. 12 It is a diagram illustrating an example of a data structure of a user information storage unit according to a third example embodiment.

FIG. 13 It is a diagram illustrating an example of a functional configuration of a first apparatus according to a fourth example embodiment.

FIG. 14 It is a diagram illustrating an example of information stored in a wayside area information storage unit.

FIG. 15 It is a flowchart illustrating an example of processing performed by a point management system according to the fourth example embodiment.

### DESCRIPTION OF EMBODIMENTS

Example embodiments of the present invention will be described below by using drawings. Note that in every drawing, similar components are given similar signs, and description thereof is omitted as appropriate.

### First Example Embodiment

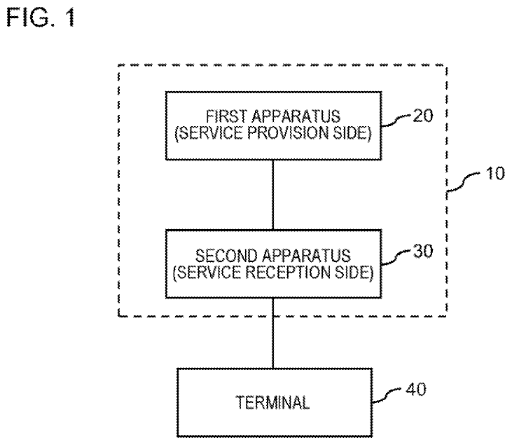

FIG. 1 is a diagram illustrating an outline of a configuration of a point management system 10 according to the present example embodiment along with a terminal 40. The point management system 10 manages one or more points (hereinafter described as first points) that are used when a person receives provision of a service. First points are managed for each group. First points are granted to the group before a service is provided. The number of first points granted to the group is proportional to an amount previously paid by the group. For example, the number of initially granted first points is equal to an amount previously paid by the group. Note that the number of the initially granted first points may be granted by credit.

A person to receive provision of a service (hereinafter described as a user) makes an application for receiving a service to the point management system 10 by operating the terminal 40. For example, the terminal 40 is a mobile terminal such as a smartphone. In the application, the terminal 40 transmits, to the point management system 10, information (hereinafter described as service determination information) for determining a service (hereinafter described as a first service) received by the user at that time along with information for determining the user (hereinafter described as person determination information). Then, the point management system 10 performs processing required for provision of the first service. Note that while examples of the person determination information include biometric information such as facial information and fingerprint information of the user, the person determination information may be an ID composed of a string of at least one type out of characters, numerals, and symbols.

The point management system 10 determines the number of first points required for the first service (hereinafter described as the number of required points). The point management system 10 uses the service determination information in the processing. Further, when the number of required points varies by an attribute of a user, the point management system 10 determines the attribute of the user by using the aforementioned person determination information and determines the number of required points by using the attribute. Then, the point management system 10 reduces first points of a group to which the user belongs by the number of required points.

Examples of a service according to the present example embodiment include provision of a public service and sale of merchandise. Examples of a provided public service include travel by a public transportation system such as a railroad, a bus, and an airplane, and provision of food and drink.

Further, examples of a group include an organization such as an enterprise. Note that one group may include a plurality of organizations, or one organization may be divided into a plurality of groups.

In the example illustrated in this diagram, the point management system 10 includes a first apparatus 20 and a second apparatus 30. The first apparatus 20 is provided in relation to a person or an organization (enterprise) providing a service and determines the number of points required for provision of the service. The second apparatus 30 is provided in relation to the aforementioned group and performs processing required for management of first points and provision of a service. Then, the terminal 40 communicates with the second apparatus 30. Therefore, the aforementioned service determination information is transmitted to the second apparatus 30. Note that management of first points may be performed by the first apparatus 20. Further, the first apparatus 20 and the second apparatus 30 may be integrated into a single apparatus.

In this diagram, the point management system 10 includes one each of the first apparatus 20 and the second apparatus 30. However, when a plurality of persons or organizations (enterprises) providing services exist, the first apparatus 20 is preferably provided for each person or organization. Further, when a plurality of groups receiving provision of services exist, the second apparatus 30 is preferably provided for each of a plurality of groups. Thus, the point management system 10 may include one first apparatus 20 and a plurality of second apparatuses 30, may include a plurality of first apparatuses 20 and one second apparatus 30, or may include a plurality of first apparatuses 20 and a plurality of second apparatuses 30.

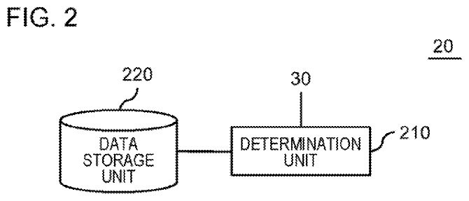

FIG. 2 is a diagram illustrating an example of a functional configuration of the first apparatus 20. As described above, the first apparatus 20 is provided in relation to a person or an organization (enterprise) providing a service. The first apparatus 20 includes a determination unit 210 and a data storage unit 220.

The determination unit 210 acquires the aforementioned service determination information from the second apparatus 30. When a first service is travel using a public transportation system, the service determination information includes, for example, a point of embarkation (such as a station of embarkation or a stop of embarkation) and a point of disembarkation (such as a station of disembarkation or a stop of disembarkation), and the information may further include information indicating a date and time of the ride.

Then, determination unit 210 determines the aforementioned number of required points by using the service determination information. At this time, the determination unit 210 uses information stored in the data storage unit 220. For example, the information is information in which service determination information and the number of required points are associated with each other. For example, when a first service is travel using a public transportation system, the determination unit 210 stores the number of required points for each combination of a point of embarkation and a point of disembarkation.

Note that when the number of required points varies by a date and time at which provision of the first service is received, the determination unit 210 further stores the number of required points for each date and time. This is for supporting a so-called time difference ticket.

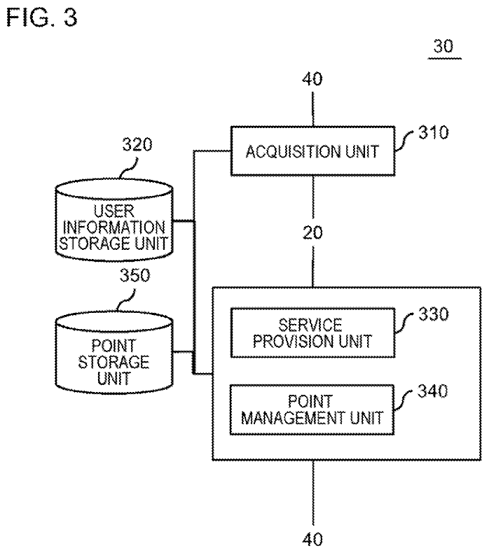

FIG. 3 is a diagram illustrating an example of a functional configuration of the second apparatus 30. In the example illustrated in this diagram, the second apparatus 30 includes an acquisition unit 310, a service provision unit 330, a point management unit 340, and a point storage unit 350.

The acquisition unit 310 acquires service determination information from the terminal 40 and transmits the information to the first apparatus 20. At this time, the acquisition unit 310 acquires person determination information from the terminal 40 and acquires attribute information of the user by using information stored in a user information storage unit 320. Then, the acquisition unit 310 also transmits the attribute information to the first apparatus 20. Note that the user information storage unit 320 stores person determination information in association with attribute information of a user related to the person determination information. While the user information storage unit 320 is part of the second apparatus 30 in the example illustrated in this diagram, the unit may be provided outside the second apparatus 30.

The service provision unit 330 receives the number of required points from the first apparatus 20 and performs processing for providing a first service to a user (hereinafter described as service provision processing). Examples of the service provision processing include generation of ticket information required for receiving the first service and transmission of the ticket information to the terminal 40.

Note that the processing for providing a first service to a user varies by the type of the first service. Therefore, part of the function of the service provision unit 330 may be provided in the first apparatus 20.

The point storage unit 350 stores the balance of first points and also stores a use history of first points. Then, after the service provision unit 330 performs the service provision processing, the point management unit 340 updates information stored in the point storage unit 350. In the update, the point management unit 340 reduces the balance of the first points by the number of required points and also updates the use history of first points. Note that the timing when the point management unit 340 performs the processing is not limited to that of this example.

Note that the point management unit 340 and the point storage unit 350 may be provided in the first apparatus 20.

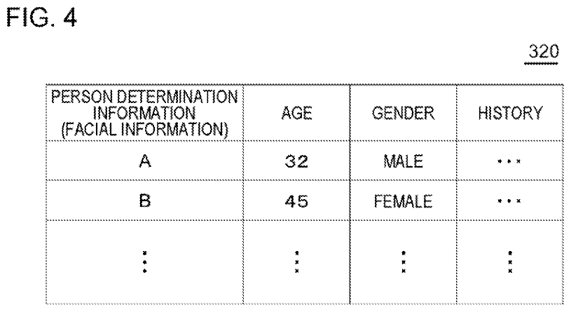

FIG. 4 is a diagram illustrating an example of information stored in the user information storage unit 320. As described above, the user information storage unit 320 stores person determination information in association with attribute information of a user related to the person determination information. As described above, person determination information may be biometric information such as facial information or an ID. Examples of attribute information include age and gender. Further, the user information storage unit 320 may store person determination information in association with a utilization history of first points (such as ticket information being used) of a user related to the person determination information. Examples of a utilization history of first points include information for determining a first service received by the user, the date and time at which the first service is received, and the number of first points consumed at that time.

Note that when the second apparatus 30 manages a plurality of groups, the user information storage unit 320 stores the information illustrated in FIG. 4 for each group.

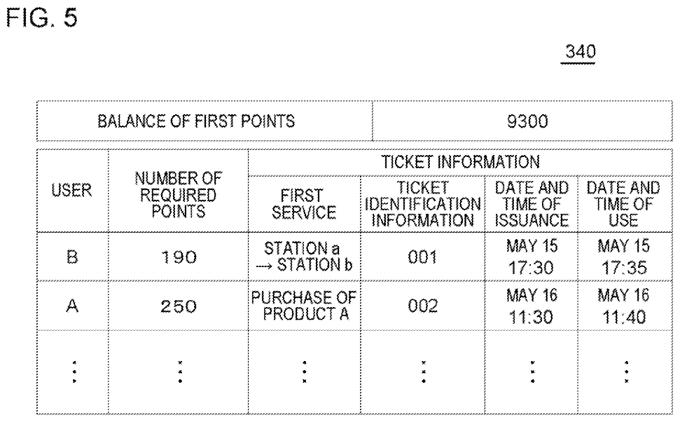

FIG. 5 is a diagram illustrating an example of information stored in the point management unit 340. The point management unit 340 stores the balance of first points and a use history of first points. A use history of first points includes person determination information of a user receiving a first service, the number of consumed first points, and ticket information. For example, ticket information is an electronic ticket and includes information for determining a first service, ticket identification information, the date and time of generation (issuance) of the ticket information, and the date and time at which the first service is received. Ticket information may further include an expiration date.

Note that when the second apparatus 30 manages a plurality of groups, the point management unit 340 stores the information illustrated in FIG. 5 for each group.

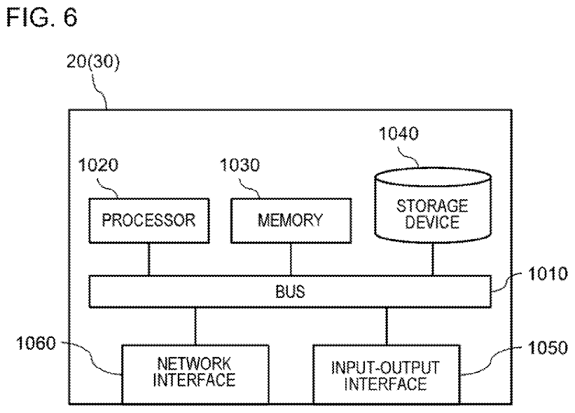

FIG. 6 is a diagram illustrating a hardware configuration example of the first apparatus 20. The first apparatus 20 includes a bus 1010, a processor 1020, a memory 1030, a storage device 1040, an input-output interface 1050, and a network interface 1060.

The bus 1010 is a data transmission channel for the processor 1020, the memory 1030, the storage device 1040, the input-output interface 1050, and the network interface 1060 to transmit and receive data to and from each another. Note that the method for interconnecting the processor 1020 and other components is not limited to a bus connection.

The processor 1020 is a processor provided by a central processing unit (CPU), a graphics processing unit (GPU), or the like.

The memory 1030 is a main storage provided by a random-access memory (RAM) or the like.

The storage device 1040 is an auxiliary storage provided by a hard disk, a solid-state drive (SSD), a memory card, a read-only memory (ROM), or the like. The storage device 1040 stores program modules providing functions of the first apparatus 20 (such as the determination unit 210). By reading each program module into the memory 1030 and executing the program module by the processor 1020, each function related to the program module is provided. Further, the storage device 1040 also functions as the data storage unit 220.

The input-output interface 1050 is an interface for connecting the first apparatus 20 to various types of input/output equipment.

The network interface 1060 is an interface for connecting the first apparatus 20 to a network. Examples of the network include a local area network (LAN) and a wide area network (WAN). The method for connecting the network interface 1060 to the network may be a wireless connection or a wired connection. The first apparatus 20 may communicate with the second apparatus 30 through the network interface 1060.

Note that a hardware configuration of the second apparatus 30 is similar to the example illustrated in FIG. 6. Then, the storage device 1040 stores program modules providing functions of the second apparatus 30 (such as the acquisition unit 310, the service provision unit 330, and the point management unit 340). Further, the storage device 1040 also functions as the user information storage unit 320 and the point storage unit 350.

Further, when the point management system 10 is provided by a single apparatus, the storage device 1040 stores program modules providing the functions of the first apparatus 20 and program modules providing the functions of the second apparatus 30. Further, the storage device 1040 also functions as the data storage unit 220, the user information storage unit 320, and the point management unit 340.

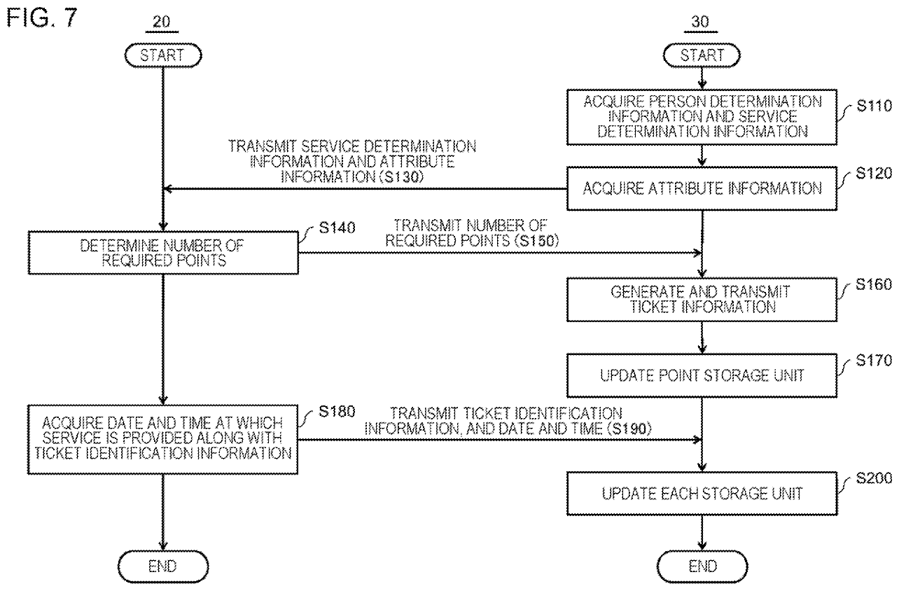

FIG. 7 is a diagram illustrating an example of processing performed by the point management system 10 when a user uses a first service. First, the user inputs service determination information to the terminal 40. At this time, the terminal 40 may acquire information indicating the balance of first points from the second apparatus 30 and display the balance on a screen of the terminal 40. Then, the terminal 40 transmits the service determination information to the second apparatus 30 along with person determination information of the user. When the person determination information is biometric information such as facial information, the terminal 40 acquires the person determination information on the spot by using a sensor included in the terminal 40 and transmits the information to the second apparatus 30.

The acquisition unit 310 in the second apparatus 30 acquires the person determination information and the service determination information from the terminal 40 (Step S110). Next, the acquisition unit 310 acquires attribute information related to the person determination information from the user information storage unit 320 (Step S120) and transmits the acquired attribute information to the first apparatus 20 along with the service determination information transmitted by the terminal 40 (Step S130). At this time, the acquisition unit 310 preferably does not transmit information by which the user is determined (such as the person determination information) to the first apparatus 20.

Next, the determination unit 210 in the first apparatus 20 determines the number of required points by using the service determination information and the information stored in the data storage unit 220 (Step S140). For example, when the service determination information includes a point of embarkation and a point of disembarkation of a public transportation system, the determination unit 210 determines the number of required points for traveling from the point of embarkation to the point of disembarkation. When the number of required points varies by an attribute (such as age) of a person receiving the service, the determination unit 210 computes the number of required points by further using the attribute information acquired from the second apparatus 30. Further, when the number of required points varies by the date and time of the ride, the service determination information includes the date and time of the ride. Then, the determination unit 210 determines the number of required points by further using the date and time of the ride. Then, the determination unit 210 transmits the determined number of required points to the second apparatus 30 (Step S150).

Next, the service provision unit 330 in the second apparatus 30 generates ticket information required for the user to receive the first service and transmits the generated ticket information to the terminal 40 (Step S160). Further, the point management unit 340 stores the ticket information issued by the service provision unit 330 into the point management unit 340 in association with the person determination information of the user and reduce the first points by the number of required points (Step S170). A date and time of use-field in the ticket information is left blank in this state.

Note that when the balance of the first points is less than the number of required points, the service provision unit 330 does not perform the processing in and after Step S160.

Subsequently, the user receives provision of the first service by using the ticket information stored in the terminal 40. Then, the first apparatus 20 acquires the date and time at which the first service is provided along with the ticket identification information (Step S180). Then, the first apparatus 20 transmits the ticket identification information and the date and time to the second apparatus 30 (Step S190).

Subsequently, the point management unit 340 stores the date and time acquired in Step S190 into a date and time of use-field related to the ticket identification information. Further, the point management unit 340 updates a history field in the user information storage unit 320. Specifically, the point management unit 340 reads ticket information and person identification information related to the ticket identification information acquired in Step S190 and stores the read ticket information into a history field related to the read person identification information (Step S200).

Note that the ticket information includes the ticket identification information. Then, when the first service is used by using the ticket information, the terminal 40 may acquire the person determination information of the user and transmit the person determination information to the second apparatus 30 along with the ticket identification information. In this case, when the combination of the person determination information and the ticket identification information matches the information stored in the point management unit 340, the second apparatus 30 transmits information for permitting use of the ticket information to the terminal 40. After receiving the information, the terminal 40 enables use of the ticket information.

Further, the acquisition unit 310 in the second apparatus 30 may transmit the person determination information and the ticket identification information to the first apparatus 20 after Step S160 and before Step S190. In this case, when the first service is provided to the user, the first apparatus 20 acquires person determination information from the terminal 40 along with the ticket information. Then, when the combination of the ticket identification information included in the ticket information and the person determination information matches a combination of the ticket identification information and the person determination information acquired from the second apparatus 30, the first apparatus 20 may perform processing for providing the first service.

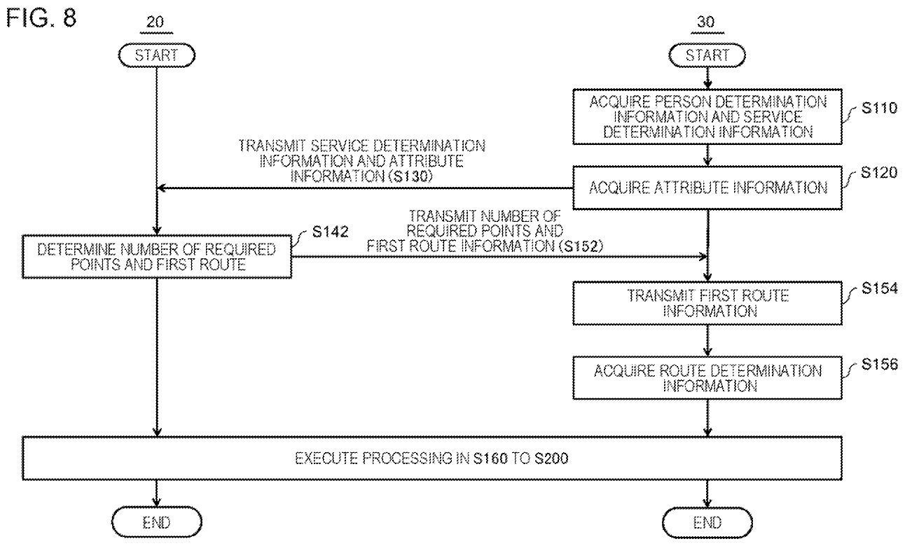

FIG. 8 is a flowchart illustrating a modified example of FIG. 7. In the example illustrated in this diagram, a first service is travel using a public transportation system such as a train and/or a bus. Therefore, service determination information includes a point of embarkation and a point of disembarkation. Then, processing performed in Step S110 to Step S130 is similar to that in the example illustrated in FIG. 7.

When acquiring service determination information and attribute information from the second apparatus 30 (Step S130), the determination unit 210 in the point management system 10 acquires, by using a point of embarkation and a point of disembarkation included in the service determination information, information indicating a route from the point of embarkation to the point of disembarkation (hereinafter described as route information). At this time, the determination unit 210 may generate the route information by using the information stored in the data storage unit 220 or may acquire the route information from an external apparatus. The route information may indicate one route or may indicate a plurality of routes. Further, at least one of routes indicated by the route information may be a desirable route for the public transportation system. For example, such a route is a route for avoiding congestion in a specific section (hereinafter described as a bypass route).

Further, the determination unit 210 determines the number of required points. When the route information indicates a plurality of routes and the number of required points for at least one route is different from the numbers of required points of other routes (for example, when the number of required points of a bypass route is less than the numbers of required points of other routes), the determination unit 210 determines the number of required points for each route (Step S142). Then, the determination unit 210 transmits the route information to the second apparatus 30 along with the numbers of required points (Step S152).

When acquiring the numbers of required points and the route information from the first apparatus 20, the service provision unit 330 in the second apparatus 30 transmits the pieces of information to the terminal 40 (Step S154).

When acquiring the numbers of required points and the route information from the second apparatus 30, the terminal 40 displays routes indicated by the route information and the numbers of required points on the screen. The user inputs information for finalizing a route to be used by operating the terminal 40. When the route information indicates one route, the user inputs information to the effect that the route is acceptable. Further, when the route information indicates a plurality of routes, the user inputs information indicating a selected route. Then, the terminal 40 transmits information indicating the finalized route (hereinafter described as route determination information) to the second apparatus 30.

When acquiring the route determination information from the terminal 40 (Step S156), the second apparatus 30 performs the processing described in Step S160 to Step S200 on the route indicated by the route determination information. Details of the processing are as described by using FIG. 7.

Note that in the processing illustrated in FIG. 8, the processing described in Steps S154 and S156 may not be performed. In this case, the service provision unit 330 transmits the route information along with the ticket information in Step S160.

Note that the point management system 10 may further divide a plurality of users belonging to the same group into a plurality of subgroups and manage the subgroups and may manage first points for each subgroup. In this case, the user information storage unit 320 stores person determination information in association with determination information of a subgroup to which a person related to the person determination information belongs. Further, the point management unit 340 manages the balance of first points for each subgroup. For example, in Step S170 in FIG. 7, the point management unit 340 reads determination information of a subgroup related to person determination information being a processing target from the user information storage unit 320 and reduces the balance of first points related to the read determination information by the number of required points.

Further, the point management system 10 may manage first points in predetermined units (hereinafter described as licenses). For example, the predetermined unit is 10 points but is not limited thereto. Thus, for example, a predetermined number of licenses may be given for each of the predetermined subgroups, thereby facilitating management and use of first points, or management of a reserved service.

Further, the point management system 10 may set a usable date and time or an expiration date of first points for each license or may previously change a predetermined number of licenses to a predetermined service [for example, a one-day ticket for one day (such as an excursion ticket or an unlimited ride ticket)]. In this case, when first points or a service not consumed within a usable date and time or before an expiration date exists, corresponding points may be returned or consumed.

Furthermore, there is a service for which the number of required points is determined only after the service is used (such as use of a taxi). When such a service is used, the point management system 10 may issue ticket information for using the service in a state of the number of required points being undetermined. In this case, in Step S170 in FIG. 7, the point management unit 340 does not update the balance of the first points. Instead, the first apparatus 20 acquires the number of required points along with ticket identification information in Step S180 in FIG. 7. Then, in Step S190 in FIG. 7, the first apparatus 20 also transmits the number of required points. Then, in Step S200 in FIG. 7, the point management unit 340 reduces the balance of the first points by the number of required points.

As described above, a group to which a plurality of persons belong (such as an enterprise) previously pays a price to a person or an organization (including an enterprise) providing a service and is granted first points, according to the present example embodiment. When a person belonging to the group receives a service, the point management system 10 reduces the first points by the number of points required for receiving the service. Accordingly, the person belonging to the group does not need to pay the price when receiving the service. Further, the person receiving the service does not advance the price, and therefore the group to which the person belongs does not need to pay an advanced amount to the person receiving the service. Furthermore, since first points are previously granted to the group, processing to be performed by the group after provision of the service is reduced. Accordingly, efforts by both the group and the person are reduced.

### Second Example Embodiment

A point management system 10 according to the present example embodiment is similar to the point management system 10 according to the first example embodiment except for a function of a second apparatus 30.

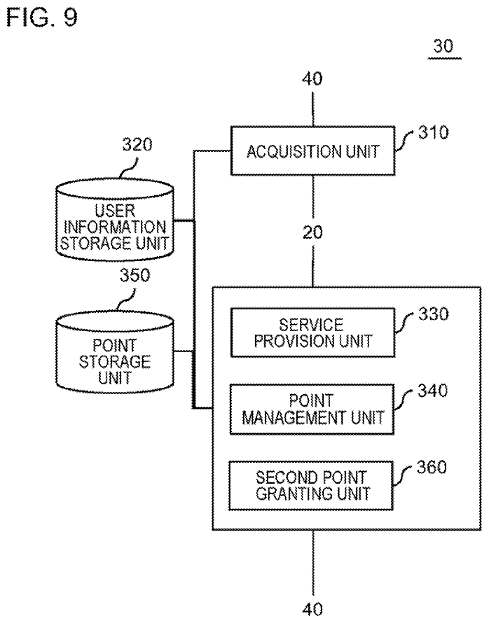

FIG. 9 is a diagram illustrating an example of a functional configuration of a first apparatus 20 according to the present example embodiment. The first apparatus 20 illustrated in this diagram is configured similarly to the second apparatus 30 illustrated in FIG. 3 except for including a second point granting unit 360.

The second point granting unit 360 performs processing for granting one or more second points to a group to which a person having received a first service belongs by using at least either of service determination information and the number of required points. For example, a second point is a mileage point and may be used for at least either one of a first service and a service other than the first service (hereinafter described as a second service). For example, the second point granting unit 360 computes the number of second points to be granted by multiplying the number of used first points by a predetermined coefficient. For example, the predetermined coefficient may be determined according to the type of the first service or may be a fixed value. Note that the first service for which second points are granted may be limited to part of the service.

Further, as described by using FIG. 8, a first service is travel using a public transportation system such as a train and/or a bus, and route information may be transmitted to a terminal 40. In this case, second points may be granted when a user uses a specific route (for example, a route desirable for the public transportation system such as a route for avoiding congestion) (that is, when the user selects the specific route).

The number of second points and a utilization history thereof are stored in a point storage unit 350. Then, the second point granting unit 360 updates the point storage unit 350 by using granted second points. Note that second points are used by a method similar to that for first points.

Note that when the point management unit 340 and the point storage unit 350 are provided to the first apparatus 20, the second point granting unit 360 may be provided to the first apparatus 20.

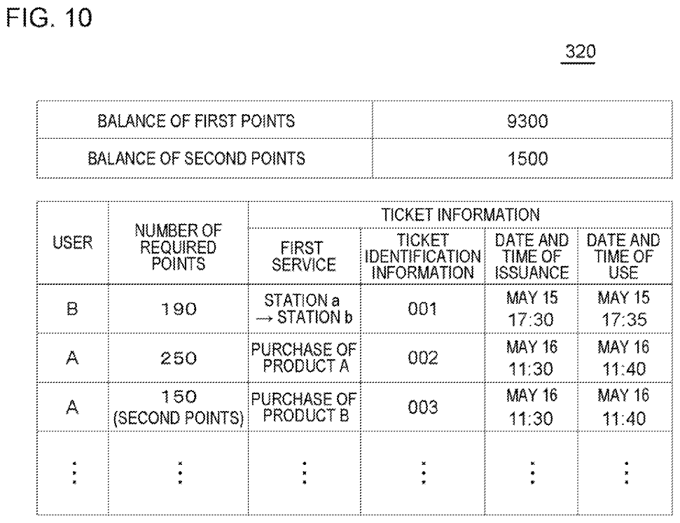

FIG. 10 is a diagram illustrating a first example of a data structure of the point storage unit 350 according to the present example embodiment. The point storage unit 350 stores the balance of second points in addition to the balance of first points. When granting second points, the second point granting unit 360 increases the balance of second points stored in the point storage unit 350. Further, when second points are used, the second point granting unit 360 reduces the balance of the second points by the number of used points. Further, the point storage unit 350 also stores information indicating whether used points are first points or second points as part of a utilization history of points.

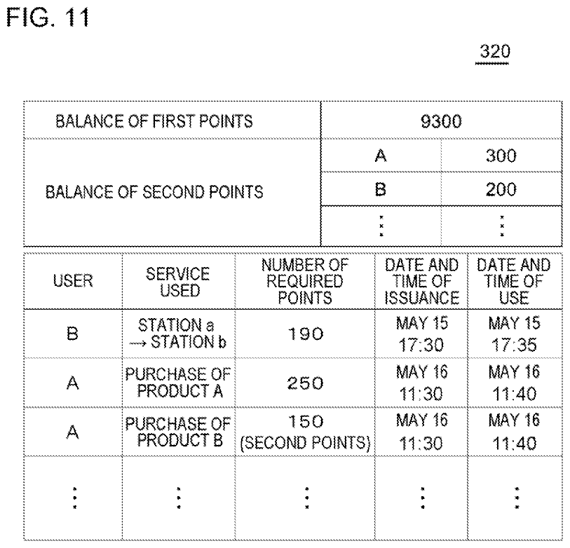

FIG. 11 is a diagram illustrating a second example of a data structure of the point storage unit 350 according to the present example embodiment. In the example illustrated in this diagram, the second point granting unit 360 grants second points to a user having used a first service. Then, the point storage unit 350 manages second points for each user. Specifically, the point storage unit 350 stores second points for each piece of person identification information.

The present example embodiment also reduces efforts by both a group and a person, similarly to the first example embodiment. Further, the point management system 10 can grant second points to a group or a person.

### Third Example Embodiment

A point management system 10 according to the present example embodiment is configured similarly to one of the aforementioned example embodiments except that first points are managed for each provider of a first service.

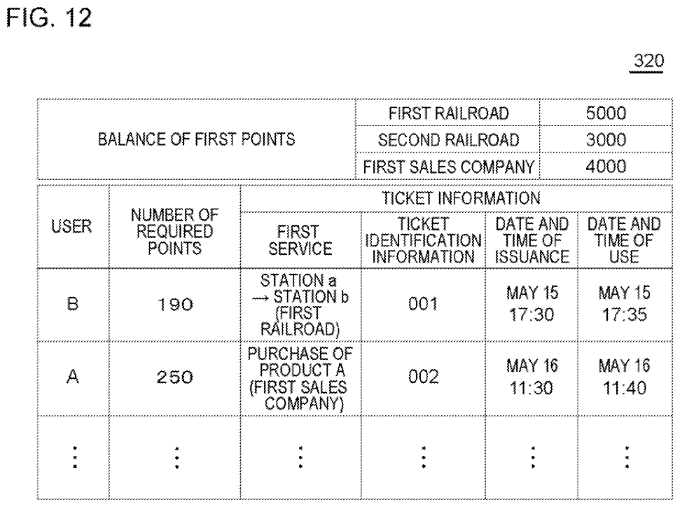

FIG. 12 is a diagram illustrating an example of a data structure of a user information storage unit 320 according to the present example embodiment. In the example illustrated in this diagram, the user information storage unit 320 stores the balance of first points for each provider of a first service. Further, ticket information also includes information for determining a provider of a service. Then, when a first service is provided, a point management unit 340 determines a provider of the service by using ticket identification information acquired in Step S190 in FIG. 7 and the like and reduces the balance of first points related to the determined provider by the number of required points.

The present example embodiment also reduces efforts by both a group and a person, similarly to the first example embodiment.

### Fourth Example Embodiment

A point management system 10 according to the present example embodiment is configured similarly to the point management system 10 according to one of the aforementioned example embodiments except for the following points. Note that a first service according to the present example embodiment is travel using a public transportation system such as a train and/or a bus.

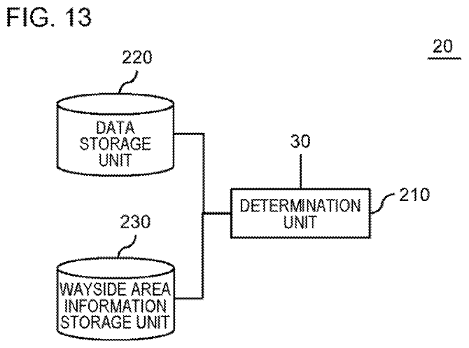

FIG. 13 is a diagram illustrating an example of a functional configuration of a first apparatus 20 according to the present example embodiment. In the example illustrated in this diagram, a determination unit 210 transmits wayside area information to a second apparatus 30 along with the number of required points. Wayside area information is information about a wayside area on a travel route indicated by a first service and is stored in a wayside area information storage unit 230. For example, wayside area information is an advertisement of a store existing in the wayside area but is not limited thereto. Note that the wayside area information storage unit 230 may be part of the first apparatus 20 or may be provided outside the first apparatus 20.

Then, a service provision unit 330 in the second apparatus 30 transmits the wayside area information acquired from the determination unit 210 to a terminal 40 along with ticket information.

Note that the wayside area information storage unit 230 may be used by the second apparatus 30. In this case, the service provision unit 330 selects wayside area information.

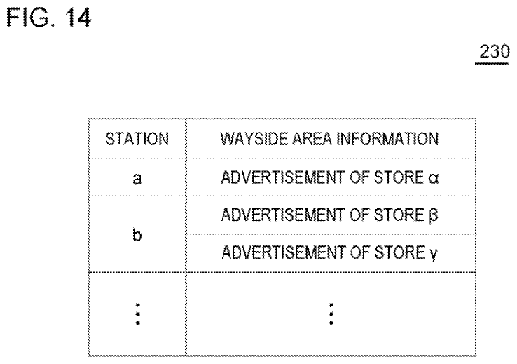

FIG. 14 is a diagram illustrating an example of information stored in the wayside area information storage unit 230. In the example illustrated in this diagram, the wayside area information storage unit 230 stores wayside area information (such as advertisement information) for each location (for example, for each station or for each stop). Then, the determination unit 210 (or the service provision unit 330) determines at least one location included in a route and reads wayside area information related to the determined location from the wayside area information storage unit 230.

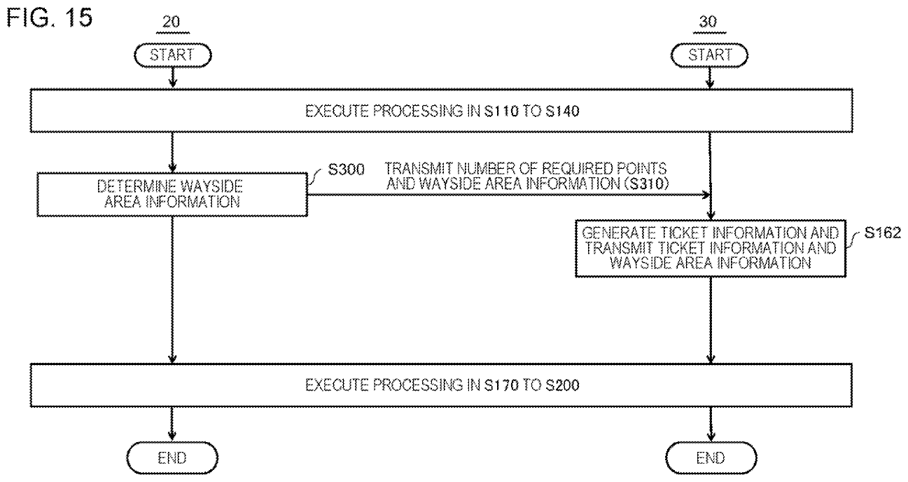

FIG. 15 is a flowchart illustrating an example of processing performed by the point management system 10 according to the present example embodiment. In this diagram, processing in Step S110 to Step S140 is similar to the example illustrated in FIG. 7. After determining the number of required points (Step S140), the determination unit 210 reads wayside area information from the wayside area information storage unit 230 (Step S300). Then, the determination unit 210 transmits the wayside area information to the second apparatus 30 along with the number of required points (Step S310).

When generating ticket information, the service provision unit 330 in the second apparatus 30 transmits the wayside area information to the terminal 40 along with the ticket information (Step S162). The terminal 40 displays the wayside area information on a screen along with the ticket information. Subsequent processing (Step S170 to S200) is as described by using FIG. 7.

Note that the processing described in Steps S300, S310, and S162 in this diagram may be performed in the example illustrated in FIG. 8. In this case, first route information is acquired in Step S300, the first route information is also transmitted to the second apparatus 30 in Step S310, and the first route information is also transmitted in Step S162. Then, the processing described in Step S156 is performed after Step S162.

The present example embodiment also reduces efforts by both a group and a person, similarly to the first example embodiment. Further, information about a wayside area on a travel route can be provided to a user.

While the example embodiments of the present invention have been described above with reference to the drawings, the example embodiments are exemplifications of the present invention, and various configurations other than those described above may be employed.

Further, while a plurality of steps (processing) are described in a sequential order in each of a plurality of flowcharts used in the aforementioned description, the execution order of steps executed in each example embodiment is not limited to the order of description. The order of the illustrated steps may be modified without affecting the contents in each example embodiment. Further, the aforementioned example embodiments may be combined without contradicting one another.

The whole or part of the example embodiments disclosed above may also be described as, but not limited to, the following supplementary notes.

1. A point management system managing one or more first points required for receiving a first service, the first points being managed for each group to which a plurality of persons belong, the point management system including:
an acquisition unit that acquires service determination information for determining a type of the first service provided to a user being one of the plurality of persons;
a determination unit that determines a number of one or more required points being a number of the one or more first points required for the first service by using the service determination information;
a service provision unit that performs processing for providing the first service to the user; and
a point management unit that reduces the first points by the number of required points.
   2. The point management system according to aforementioned 1, in which
the first points are further managed for each provider of the first service, and
the point management unit reduces the first points of a provider of the first service by the number of required points.
   3. The point management system according to aforementioned 1 or 2, in which
the service is travel using a public transportation system.
   4. The point management system according to aforementioned 3, in which
the determination unit determines the number of required points by using a date and time at which the first service is provided.
   5. The point management system according to aforementioned 3 or 4, in which
the service provision unit acquires wayside area information being information about a wayside area on a route of the travel and transmits the wayside area information to a terminal of the user.
   6. The point management system according to any one of aforementioned 1 to 5, further including:
a first apparatus including the determination unit; and
a second apparatus including the acquisition unit, in which
the service provision unit is provided to at least either one of the first apparatus and the second apparatus.
   7. The point management system according to aforementioned 6, in which
the second apparatus transmits ticket information required for the user to receive the first service to a terminal of the user.
   8. The point management system according to any one of aforementioned 1 to 7, in which
the acquisition unit
   acquires person determination information for determining the user from a terminal operated by the user and
   generates attribute information indicating an attribute of the user by using the person determination information, and
the determination unit computes the number of required points by using the attribute information.
   9. The point management system according to any one of aforementioned 1 to 8, further including
a second point granting unit that performs processing for granting, to the group, one or more second points that can be used for at least either one of the first service and a second service, by using at least either of the service determination information and the number of required points.
   10. The point management system according to aforementioned 9, in which
the second point granting unit manages the second points for the each user.
   11. The point management system according to aforementioned 9 or 10, in which
the service is travel using a public transportation system,
the acquisition unit acquires a start point and a destination of the travel as at least part of the service determination information,
the determination unit determines a specific route being a route from the start point to the destination by using the start point and the destination and transmits information indicating the specific route to a terminal operated by the user, and
the second point granting unit grants the second point when the user uses the specific route.
   12. A point management method for managing one or more first points required for receiving a first service, the first points being managed for each group to which a plurality of persons belong, the point management method performing, by using at least one computer:
acquisition processing of acquiring service determination information for determining a type of the first service provided to a user being one of the plurality of persons;
determination processing of determining a number of one or more required points being a number of the one or more first points required for the first service by using the service determination information;
service provision processing of performing processing for providing the first service to the user; and
point management processing of reducing the first points by the number of required points.
   13. The point management method according to aforementioned 12, in which
the first points are further managed for each provider of the first service, and,
in the point management processing, the computer reduces the first points of a provider of the first service by the number of required points.
   14. The point management method according to aforementioned 12 or 13, in which
the service is travel using a public transportation system.
   15. The point management method according to aforementioned 14, in which,
in the determination processing, the computer determines the number of required points by using a date and time at which the first service is provided.
   16. The point management method according to aforementioned 14 or 15, in which,
in the service provision processing, the computer acquires wayside area information being information about a wayside area on a route of the travel and transmits the wayside area information to a terminal of the user.
   17. The point management method according to any one of aforementioned 12 to 16, in which
the at least one computer includes:
   a first computer performing the determination processing; and
   a second computer performing the acquisition processing, and
the service provision processing is performed by at least either one of the first computer and the second computer.
   18. The point management method according to aforementioned 17, in which
the second computer transmits ticket information required for the user to receive the first service to a terminal of the user.
   19. The point management method according to any one of aforementioned 12 to 18, in which,
in the acquisition processing, the computer
   acquires person determination information for determining the user from a terminal operated by the user and
   generates attribute information indicating an attribute of the user by using the person determination information, and,
in the determination, the computer computes the number of required points by using the attribute information.
   20. The point management method according to any one of aforementioned 12 to 19, further including, by the computer
second point granting processing of performing processing for granting, to the group, one or more second points that can be used for at least either one of the first service and a second service, by using at least either of the service determination information and the number of required points.
   21. The point management method according to aforementioned 20, in which,
in the second point granting processing, the computer manages the second points for the each user.
   22. The point management method according to aforementioned 20 or 21, in which
the service is travel using a public transportation system,
in the acquisition processing, the computer acquires a start point and a destination of the travel as at least part of the service determination information,
in the determination processing, the computer determines a specific route being a route from the start point to the destination by using the start point and the destination and transmits information indicating the specific route to a terminal operated by the user, and,
in the second point granting processing, the computer grants the second point when the user uses the specific route.
   23. A program for causing a system including at least one computer to operate as a point management system managing one or more first points required for receiving a first service, the first points being managed for each group to which a plurality of persons belong, the program causing the system to execute:
an acquisition function of acquiring service determination information for determining a type of the first service provided to a user being one of the plurality of persons;
a determination function of determining a number of one or more required points being a number of the one or more first points required for the first service by using the service determination information;
a service provision function of performing processing for providing the first service to the user; and
a point management function of reducing the first points by the number of required points.
   24. The program according to aforementioned 23, in which
the first points are further managed for each provider of the first service, and
the point management function reduces the first points of a provider of the first service by the number of required points.
   25. The program according to aforementioned 23 or 24, in which
the service is travel using a public transportation system.
   26. The program according to aforementioned 25, in which
the determination function determines the number of required points by using a date and time at which the first service is provided.
   27. The program according to aforementioned 25 or 26, in which
the service provision function acquires wayside area information being information about a wayside area on a route of the travel and transmits the wayside area information to a terminal of the user.
   28. The program according to any one of aforementioned 23 to 27, in which
the system includes:
   a first computer including the determination function; and
   a second computer including the acquisition function, and
at least either one of the first computer and the second computer possesses the service provision function.
   29. The program according to aforementioned 28, in which
the second computer transmits ticket information required for the user to receive the first service to a terminal of the user.
   30. The program according to any one of aforementioned 23 to 29, in which
the acquisition function
   acquires person determination information for determining the user from a terminal operated by the user and
   generates attribute information indicating an attribute of the user by using the person determination information, and
the determination function computes the number of required points by using the attribute information.
   31. The program according to any one of aforementioned 23 to 30, further causing the system to execute
a second point granting function of performing processing for granting, to the group, one or more second points that can be used for at least either one of the first service and a second service, by using at least either of the service determination information and the number of required points.
   32. The program according to aforementioned 31, in which
the second point granting function manages the second points for the each user.
   33. The program according to aforementioned 31 or 32, in which
the service is travel using a public transportation system,
the acquisition function acquires a start point and a destination of the travel as at least part of the service determination information,
the determination function determines a specific route being a route from the start point to the destination by using the start point and the destination and transmits information indicating the specific route to a terminal operated by the user, and
the second point granting function grants the second point when the user uses the specific route.

### REFERENCE SIGNS LIST

10 Point management system
20 First apparatus
30 Second apparatus
40 Terminal
210 Determination unit
220 Data storage unit
230 Wayside area information storage unit
310 Acquisition unit
320 User information storage unit
330 Service provision unit
340 Point management unit
350 Point storage unit
360 Second point granting unit

What is claimed is:

1. A point management system managing one or more first points required for receiving a first service, the first points being managed for each group to which a plurality of persons belong, the point management system comprising:
at least one memory configured to store instructions; and
at least one processor configured to execute the instructions to perform operations, the operations comprising:
acquiring service determination information for determining a type of the first service provided to a user being one of the plurality of persons;
determining a number of one or more required points being a number of the one or more first points required for the first service by using the service determination information;
performing processing for providing the first service to the user; and
reducing the first points by the number of required points.

2. The point management system according to claim 1, wherein
the first points are further managed for each provider of the first service, and
the operations further comprise reducing the first points of a provider of the first service by the number of required points.

3. The point management system according to claim 1, wherein the service is travel using a public transportation system.

4. The point management system according to claim 3, wherein
the operations further comprise determining the number of required points by using a date and time at which the first service is provided.

5. The point management system according to claim 3, wherein
the operations further comprise acquiring wayside area information being information about a wayside area on a route of the travel and transmits the wayside area information to a terminal of the user.

6. The point management system according to claim 1, comprising a first apparatus and a second apparatus, wherein
the first apparatus comprises a first memory configured to store first instructions and a first processor configured to execute the first instructions to determine the number of one or more required points,
the second apparatus comprises a second memory configured to store second instructions and a second processor configured to execute the second instructions to acquire the service determination information, and
at least either one of the first processor and the second processor is configured to execute instructions to perform the processing for providing the first service to the user.

7. The point management system according to claim 6, wherein
the second processor is further configured to execute the second instructions to transmit ticket information required for the user to receive the first service to a terminal of the user.

8. The point management system according to claim 1, wherein
the operations further comprise
acquiring person determination information for determining the user from a terminal operated by the user,
generating attribute information indicating an attribute of the user by using the person determination information, and
computing the number of required points by using the attribute information.

9. The point management system according to claim 1, wherein the operations further comprise
performing processing for granting, to the group, one or more second points that can be used for at least either one of the first service and a second service, by using at least either of the service determination information and the number of required points.

10. The point management system according to claim 9, wherein
the operations further comprise managing the second points for the each user.

11. The point management system according to claim 9, wherein
the service is travel using a public transportation system,
the operations further comprise:
acquiring a start point and a destination of the travel as at least part of the service determination information,
determining a specific route being a route from the start point to the destination by using the start point and the destination and transmitting information indicating the specific route to a terminal operated by the user, and
granting the second point when the user uses the specific route.

12. A point management method for managing one or more first points required for receiving a first service, the first points being managed for each group to which a plurality of persons belong, the point management method performing, by using at least one computer:
acquisition processing of acquiring service determination information for determining a type of the first service provided to a user being one of the plurality of persons;
determination processing of determining a number of one or more required points being a number of the one or more first points required for the first service by using the service determination information;
service provision processing of performing processing for providing the first service to the user; and
point management processing of reducing the first points by the number of required points.

13. A non-transitory computer-readable medium storing a program for causing a system including at least one computer to operate as a point management system managing one or more first points required for receiving a first service, the first points being managed for each group to which a plurality of persons belong, the program causing the system to perform operations, the operations comprising:
acquiring service determination information for determining a type of the first service provided to a user being one of the plurality of persons;
determining a number of one or more required points being a number of the one or more first points required for the first service by using the service determination information;
performing processing for providing the first service to the user; and
reducing the first points by the number of required points.
